(19) United States
(12) Patent Application Publication
(10) Pub. No.: US 2017/0364577 A1
(43) Pub. Date: Dec. 21, 2017

(54) SEARCH ENGINE DATA VALIDATION METHOD AND SYSTEM

(71) Applicant: MasterCard International Incorporated, Purchase, NY (US)

(72) Inventors: Kimberly Ann PURCELL, Wilton, CN (US); Nigel NOYES, Irvington, NY (US); Todd Christian LOWENBERG, Redding, CT (US); Nikhil Anand MALGATTI, Ridgefield, CT (US); Harry CHEN, Port Chester, NY (US)

(21) Appl. No.: 15/183,512

(22) Filed: Jun. 15, 2016

(51) Int. Cl. G06F 17/30; G06Q 40/00

(52) U.S. Cl. CPC G06F 17/30598; G06Q 40/00; G06F 17/30371; G06F 17/30867

(57) ABSTRACT

A system, method, and computer-readable storage medium configured to validate data to ensure that a computing system operates on clean, correct and useful data.

### BACKGROUND

### Field of the Disclosure

Aspects of the disclosure relate in general to computer science. Aspects include a method and system to validate data to ensure that a computing system operates on clean, correct and useful data.

### Description of the Related Art

In computer science, data validation is the process of ensuring that a program operates on clean, correct and useful data. It uses routines, often called “validation rules,” “validation constraints” or “check routines,” that check for correctness, meaningfulness, and security of data that are input to the system. The rules may be implemented through the automated facilities of a data dictionary, or by the inclusion of explicit application program validation logic.

Data validation provides certain well-defined guarantees for fitness, accuracy, and consistency for any of various kinds of user input into an application or automated system. Data validation rules can be defined and designed using any of various methodologies, and be deployed in any of various contexts.

Data validation rules may be defined, designed and deployed, in definition and design contexts, and in deployment contexts. In definition and design contexts, data validation rules are part of a requirements-gathering phase in a software engineering or designing a software specification, or as part of an operations modeling phase in business process modeling. In deployment contexts, data validation is typically incorporated as part of a user-interface.

In another field of computer science, a search engine is an information retrieval software program that discovers, crawls, transforms and stores information for retrieval and presentation in response to user queries.

Search engines normally consist of a crawler (also known as a “spider” or a “bot”) that traverses a document collection. The crawler deconstructs document text and assigns surrogates for storage in the search engine index. Online search engines store images, link data and metadata for the document as well. Although, search engines have become increasingly sophisticated in many ways, they still cannot understand a webpage the same way a human does and to make them understand what the web page is about.

### SUMMARY

Embodiments include a system, device, method and computer-readable medium to validate data to ensure that a computing system, such as a search engine, operates on clean, correct and useful data.

A device embodiment is configured to validate query result data. A network interface receives a query. The query is about a subject. The query contains a time period, and the subject has a predetermined category. A processor filters transaction data based on the time period and on an opt-in community, resulting in community data within the time period. The processor filters the community data within the time period on the predetermined category, resulting in category data. The processor determines a total number of transactions in the category data. The processor matches the subject with the category data, resulting in a number of transactions regarding the subject. The processor compares the number of transactions regarding the subject with the total number of transactions in the category data, resulting in specific comparison data. A presentation interface presents the specific comparison data on a presentation interface.

### BRIEF DESCRIPTION OF THE DRAWINGS

FIG. 1 is a block diagram illustrating a system to gather clean, and correct data.

FIG. 2 is flowchart depicting a method to ensure that a computing system operates on clean, correct and useful data.

FIG. 3 is a block diagram of an architecture embodiment to ensure that a computing system operates on clean, correct and useful data.

### DETAILED DESCRIPTION

In computer science, data validation ensures that a program operates on clean, correct and useful data. In another area of computer science, search engines return information based on queries. One aspect of the disclosure includes the realization that search engines may fail to validate the data matching a query.

When either a machine or individual queries an internet search engine, for example, the search engine may return links to web-pages based on the number of web-page views, but the search engine does not validate the data contained within the web-page. For example, suppose an individual decides to search for reviews for a product, service, or merchant retailer. The search results may contain erroneous data that are unsubstantiated.

An aspect of the disclosure is the realization that in specific instances, search query results can be validated against actual performance data.

Another aspect of the disclosure is the realization that individuals favor products, services, or merchants favored by their community. In such instances, the community may be a regional or geographic community, a community of like-minded individuals, or community of individuals affiliated with an organization. A regional or geographic community may be individuals that reside within a ZIP-code, township, city, state or province, for example. A community of like-minded individuals may be based on interests, such as fans of science fiction, collectables, sports, or other interest groups. A community of individuals affiliated with an organization may be affiliated with a corporation, non-profit agency, fraternal order, or another organization.

Yet another aspect of the disclosure is the realization that preferences reported by individuals may not match actual behavior. For example, consumers rely heavily on word of mouth to know which merchants to patronize or products to buy. Online merchant reviews are an attempt to replicate such “word of mouth” in the online context, but extreme positions tend to be overrepresented compared to actual perceptions. To date there is no way to quickly and efficiently remove these unrepresentative extremes and provide objective guidance online to consumers. Validation of reviews and other data can be provided by actual consumer spending behavior.

As a consequence, embodiments solve the technical issue of validating results provided by a search engine, allowing a system to operate on clean, correct and useful data. For illustrative purposes only, an embodiment described below validates queries related to services, products, or merchants by using actual consumer spending behavior.

The systems and processes are not limited to the specific embodiments described herein. In addition, components of each system and each process can be practiced independently and separately from other components and processes described herein. Each component and process also can be used in combination with other assembly packages and processes.

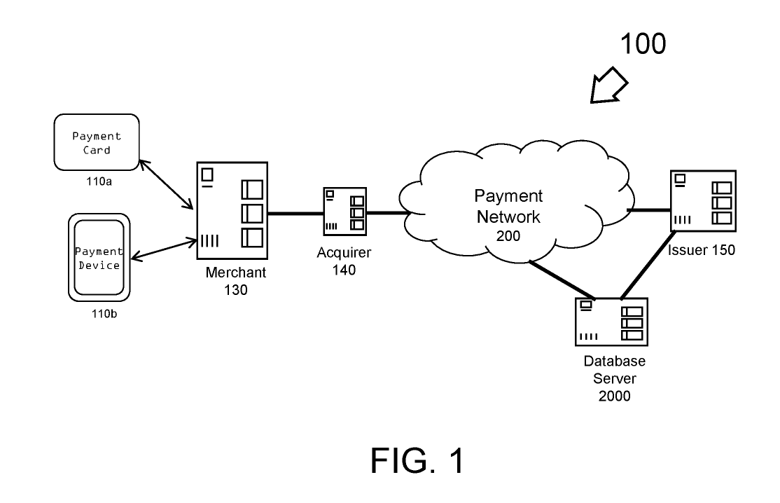

FIG. 1 is a block diagram 100 illustrating a system and to gather clean, and correct data. The present disclosure is related to a payment system, such as a credit card payment system using a payment network 200, such as the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system 100, a financial institution called the “issuer” 150 issues a payment account to a consumer, who uses payment device 110a-b to tender payment for a purchase from merchant 130. Payment devices may include a payment card 110a, or a mobile device 110b (such as key fobs, mobile phones, tablet computers, Personal Digital Assistants (PDAs), electronic wallets and the like). Payment devices may be used to tender purchase in-person at merchant 130 or conduct electronic payments over the Internet (not shown).

Opinions on products and services may be inferred from actual purchase behavior conducted by payment accountholders using the financial payment system 100.

In this example, using a payment card 110a or payment device 110b, a consumer makes a purchase at merchant 130. During the transaction, the consumer presents the payment device 110 to a point-of-sale device at the merchant 130. The merchant 130 is affiliated with a financial institution. This financial institution is usually called the “merchant bank,” “acquiring bank” “acquirer bank,” or acquirer 140. When a payment device 110 is tendered at merchant 130, the merchant 1300 electronically requests authorization from the acquirer 1400 for the amount of the purchase. The authorization request is performed electronically with the consumer's account information and transaction information that describes the details of the transaction.

For payment cards, the consumer's account information may be retrieved from the magnetic stripe on a payment card 110a or via a computer chip imbedded within the card 110a. For other types of payment devices 110b, the consumer's account information may be retrieved by wireless methods, such as contactless communication like MasterPass® or via Near Field Communication (NFC). In some embodiments, account information may be a Primary Account Number (PAN).

The transaction information is governed by International Standards Organization (ISO) standard 8583 (“ISO 8583 Financial transaction card originated messages—Interchange message specifications”). The transaction information includes encoded details of the transaction, including: transaction amount, the terminal (merchant identifier), currency type, date, and time.

The account information, along with the transaction information, is forwarded to transaction processing computers of the acquirer 140. Alternatively, an acquirer 140 may authorize a third party to perform transaction processing on its behalf. In this case, the merchant 130 will be configured to communicate with the third party. Such a third party is usually called a “merchant processor” or an “acquiring processor” (not shown).

The computers of the acquirer 140 or the merchant processor will communicate, via payment network 200, with the computers of the issuer 150 to determine whether the consumer's account is in good standing and whether the accountholder should be approved for the purchase. It is understood that any number of issuers 150 may be connected to payment network 200.

Assuming the issuer 150 approves the transaction, the payment network 200 forwards the approval to the merchant 130 via acquirer 140.

A record of transactions is stored at database server 2000. In some embodiments, database server 2000 may exist at payment network 200 or issuer 150.

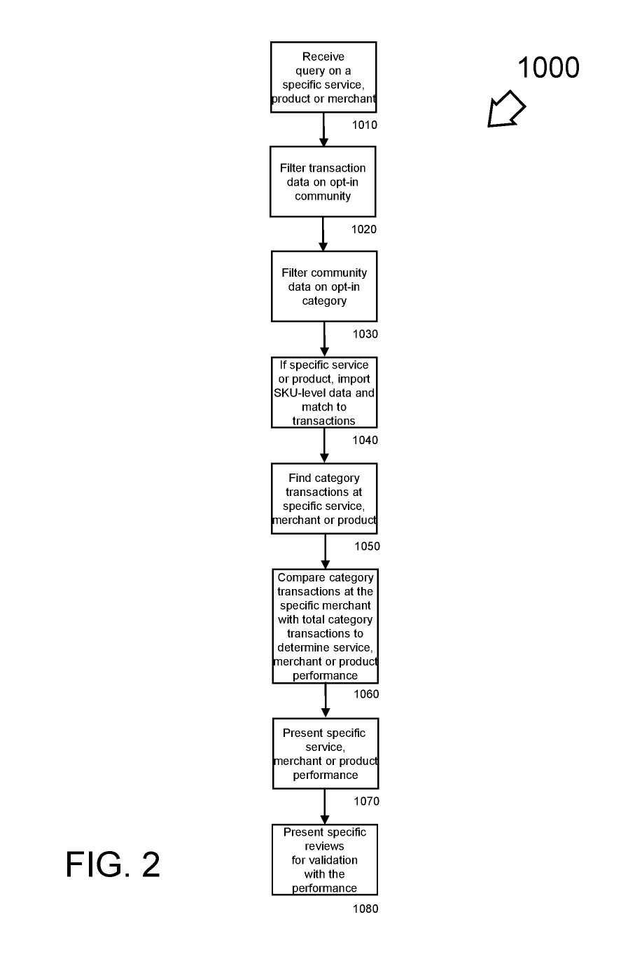

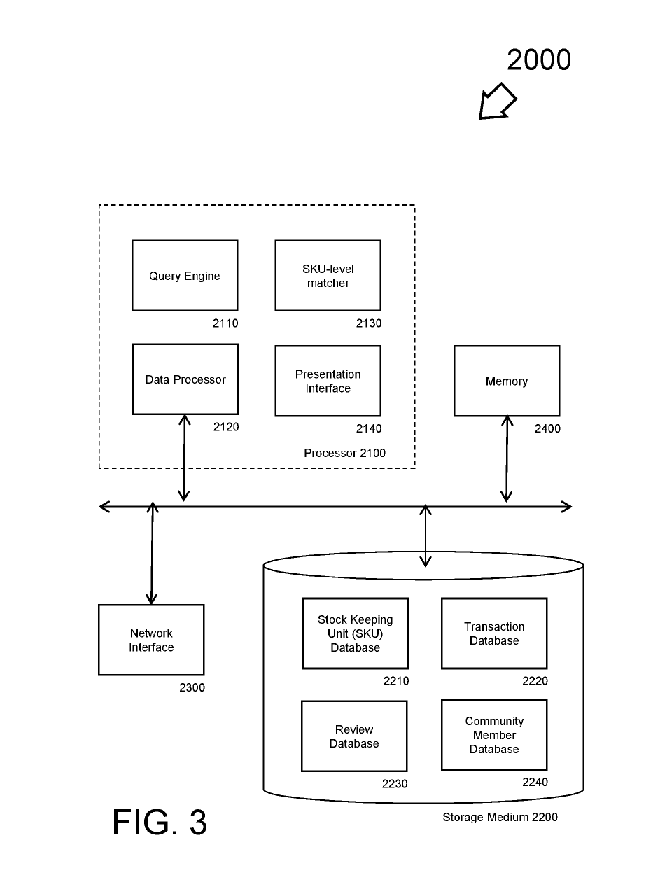

FIG. 2 is a flow chart of a process 1000 to ensure that a computing system operates on clean, correct and useful data. Process 1000 may be executed by one or more database server 2000, which is depicted in FIG. 3. Both process 1000 and database server 2000 are constructed and operative in accordance with embodiments of the present disclosure. It is understood that a system containing a plurality of database servers 2000 may implement process 1000.

Database server 2000 may run a multi-tasking operating system (OS) and include at least one processor or central processing unit (CPU) 2100, a non-transitory computer-readable storage medium 2200, and a network interface 2300.

Processor 2100 may be a central processing unit, microprocessor, micro-controller, computational device or circuit known in the art. It is understood that processor 2100 may temporarily store data and instructions in a memory 2400, such as a Random Access Memory (RAM), as is known in the art.

As shown in FIG. 3, processor 2100 is functionally comprised of a query engine 2110, a SKU-level matcher 2130, a data processor 2120, and a presentation interface 2140.

Data processor 2120 interfaces with storage medium 2200 and network interface 2300. The data processor 2120 enables processor 2100 to locate data on, read data from, and write data to, these components.

Query engine 2110 is the structure that provides database services to other programs or computers using a client-server model, and may store its information in a SQL database. An example query engine 2110 is Oracle Database, sold by Oracle Corporation of Redwood City, Calif. In particular, query engine 2110 may store or retrieve data stored in a Stock Keeping Unit (SKU) database 2210, transaction database 2220, or review database 2230. A Stock Keeping Unit is a unique identifier for each distinct product and service that can be purchased in business. It is understood that some embodiments may use other identifiers, such as the Universal Product Code (UPC), International Article Number (EAN), Global Trade Item Number (GTIN), or Australian Product Number (APN).

SKU-level matcher 2130 is a structure coupled to query engine 2110, and enables query engine 2110 to match entries in a transaction database 2220 with entries in a SKU database 2210. This matching allows a query engine 2110 to determine the goods or services (as identified by their Stock Keeping Unit) purchased in a purchase transaction.

Presentation interface 2140 is the structure that facilitates the presentation of query engine 2110 search results to a user. In some embodiments, presentation interface 2140 is a World Wide Web server. In other embodiments, presentation interface 2140 may transmit query engine 2110 search results to a specialized application on a mobile computing device.

These structures may be implemented as hardware, firmware, or software encoded on a computer readable medium, such as storage medium 2200. Further details of these components are described with their relation to method embodiments below.

Computer-readable storage medium 2200 may be a read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 3, storage medium 2200 may also contain a SKU database 2210, a transaction database 2220, a review database 2230, and a community member database 2240. In some embodiments, the three databases may be implemented as a single or multiple relational databases.

A transaction database 2220 contains transactions from a community of individuals that have opted-into permitting their purchase transaction data be included in the database. Additionally in some embodiments, the individuals may have permitted a subset of their purchase transaction data be included in transaction database 2220.

For example, in a system that reviews restaurants, an individual may restrict their purchase transactions to be included in transaction database 2220 to dining transactions only. In such an example, the dining transactions may include the date and time of the transaction, amount of transaction, and a merchant (restaurant) identifier. Each dining transaction by the individual accountholder would be included into the database.

In an alternate example, in a system that reviews products, the individual may permit all their purchase transactions at retailers to be included in the transaction database 2220.

A SKU database 2210 allows the database server 2000 to match the date, time, and location of a transaction with items purchased during the transaction.

A review database 2230 may contain user written reviews of products, services, and/or merchants.

Community member database 2240 is a data structure containing individuals that have opted into a community. In addition to listing individuals, in some embodiments, the community member database 2240 also contains at least one payment card identifier associated with an individual. The payment card identifier may be a Primary Account Number (PAN), a hashed PAN, or other payment card identifier known in the art.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows database server 2000 to with other database servers.

We now return our attention to a method or process embodiment of the present disclosure, as shown in FIG. 2. It is understood by those known in the art other equivalent implementations can exist without departing from the spirit or claims of the disclosure.

The method 1000 ensures that a computing system can quickly and efficiently validate the results of a query search with transaction data illustrating actual service, product, or merchant performance. In some embodiments, the validation occurs through a statistical validation. For example, a restaurant that generally has high reviews may have the reviews validated by frequent repeat visits or purchases (as shown by the transaction data) by individuals.

At block 1010, presentation interface 2140 receives a query on a specific service, product or merchant. In some instances, the query may be received over a telecommunications network by the database server 2000 with the network interface 2300. In some embodiments, the query also contains a time period over which the service, product or merchant is being evaluated.

In some embodiments, query engine 2110 filters transaction data stored in the transaction database 2220, retaining only transaction data from those that have opted into a community of reviewers as stored in a community member database 2240, block 1020. It is understood that the results of the query engine 2110 may be loaded, filtered, and manipulated in a data structure temporarily stored in memory 2400.

As mentioned above, the community may be based on a regional or geographic affiliation (e.g., a city, state, country, ZIP code, and the like), an affiliation of like-minded individuals, or a community of individuals affiliated with an organization. In some instances, this is not necessary because transaction database 2220 may only contain transaction data from those that have already opted into the community. The filtered data is referred to as “community data.”

For the product, service, or merchant being queried, the product, service or merchant is related to a category of products, services, or merchants. Merchants may be categorized based on Merchant Category Code (MCC), as defined by Internal Revenue Bulletin: 2004-31 at https://www.irs.gov/irb/2004-31_IRB/ar17.html, and highly curated lists of industries and sub-industries. For example, a café being queried falls within a restaurant category, which is a merchant category. Restaurants may be further divided into sub-categories, based on cuisine, fast-food, fine-dining, and the like. A specific auto repair store falls within a category of auto repair, and so on. Products and services are similarly pre-categorized. Individuals may have opted in their transaction data for only specific categories. Consequently at block 1030, the community data is filtered on transactions that have opted-into the category being searched.

If the query involves a product or service, SKU-level data is imported to match the transactions, to determine the transactions that match the product or service being queried, block 1040. For example, if the query relates to a specific television set being purchased, the SKU associated with the television is used to match all transactions involving the specific television set.

The transactions that fall within the category being searched (“category transactions”) are found at block 1050. For example, suppose the search is related to a merchant, such as the café mentioned above. All the transactions that have occurred at the café and its competitive set of merchants are found at block 1050. Parameters used in generating the competitive merchant set may include, without limitation, location, sales volume, transaction volume, and ticket size. If the category is a product, such as a specific model of television, for example, then all the transactions that involve that model of television are found (in conjunction with the SKU database 2210) and regardless of merchant, at block 1050.

The category transactions at the specific merchants are compared with the total category transactions within that category, block 1060. Using one of the above examples, transactions that occurred at the café, a specific merchant, are compared with the transactions relating to the restaurant category (the total category transactions). From the comparison, service, merchant, or product performance within the category can be determined. Factors used in the comparison may include, but is not limited to: frequency of purchase, amount purchased (“average ticket size”), tenure of the business, percentage share of wallet, seasonality of purchases, time of day of purchases, and day of week of purchases.

Average frequency of purchase of a product or service can be compared to the average frequency of purchase of rival products or services. Similarly, the average frequency of purchase at a particular merchant can be compared to the average frequency of purchase at rival merchants. For example, suppose the merchant is the specific café discussed above. Query engine 2110 can determine that the average visitor to the specific café visits once a month, while the average shopper visits rival cafes once every three months. Additionally, query engine 2110 may use average frequency of purchase to show the average number of repeat visits to the merchant, and compare this to the average number of repeat visits to rival merchants in the same category.

Average amount purchased at a merchant (“ticket size”) can be compared to average amount purchased at rival merchants, or presented in an absolute amount. Continuing the café example, suppose query engine 2110 determines that the average purchase at the specific café is $25, and average purchase at the average rival cafes to be $10. Query engine 2110 can calculate and determine that the average purchase at the specific café is 2.5×larger than the average rival café.

Tenure of the business can be determined and compared to the tenure of the average rival business. Tenure of the business is the amount of time that the merchant has been in business. For example, query engine 2110 may determine that the tenure of the business at the specific café is six months, and while the average tenure of rival cafes is two years.

Percentage share of wallet is the determination of how much is spent at on particular merchant, product, or service by a consumer, compared to all other expenditures in the same category. For example, query engine 2110 may determine that the average customer spends 35% of their café spending at the specific café, and while the average customer spends 25% of their café spending at the average rival café.

Purchases may also be analyzed for a temporal component, such as the seasonality (time of year) of purchases, time of day of purchases, and day of week of purchases. Query engine 2110 may detect that some purchases may tend to be seasonal; for example, Christmas trees are usually sold in the late fall (November through December). Other purchases may be more influenced by the time of day; for example, restaurants may only be open during mid-day for lunch, or evenings for dinner. Finally, some purchases tend to occur on particular days of the week.

At block 1070, presentation interface 2140 formats and presents the query (performance) results produced by query engine 2110.

In some embodiments, reviews of the product, service or merchant can be retrieved from a review database 2230 for direct validation and presented by presentation interface 2140 with the performance determined above, block 1080.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art. Thus, the present disclosure is not intended to be limited to the embodiments shown herein, but is to be accorded the widest scope consistent with the principles and novel features disclosed herein.

What is claimed is:

1. A method of validating query result data comprising:
receiving, with a network interface, a query, the query being about a subject, the query containing a time period, and the subject having a predetermined category;
filtering, with a processor, transaction data based on the time period and on an opt-in community, resulting in community data within the time period;
filtering, with a processor, the community data within the time period on the predetermined category with the processor, resulting in category data;
determining, with a processor, a total number of transactions in the category data;
matching, with the processor, the subject with the category data, resulting in a number of transactions regarding the subject;
comparing the number of transactions regarding the subject with the total number of transactions in the category data, resulting in specific comparison data;
presenting the specific comparison data on a presentation interface.

2. The method of claim 1, further comprising:
querying a review database about the subject, resulting in reviews;
validating the reviews with the specific comparison data;
presenting the validated reviews with the specific comparison data.

3. The method of claim 2, wherein the transaction data is an accumulation of individual payment card transactions, each individual payment card transaction including: a payment card indicator, a transaction date, transaction time, and a merchant indicator.

4. The method of claim 3, wherein validating the reviews with the specific comparison data includes a statistical comparison.

5. The method of claim 4, comparing the number of transactions regarding the subject with the total number of transactions in the category data is based on: frequency of purchase, amount purchased, tenure of the business, or percentage share of the wallet.

6. The method of claim 5, wherein comparing the number of transactions regarding the subject with the total number of transactions in the category data is further based on: seasonality of purchases, time of day of purchases, or day of week of purchases.

7. The method of claim 4, further comprising:
wherein the query subject is a product or service;
wherein the matching the subject with the category data is accomplished by matching Stock Keeping Unit data within the category data.

8. A device to validate query result data comprising:
means for receiving a query, the query being about a subject, the query containing a time period, and the subject having a predetermined category;
means for filtering transaction data based on the time period and on an opt-in community, resulting in community data within the time period;
means for filtering the community data within the time period on the predetermined category, resulting in category data;
means for determining a total number of transactions in the category data;
means for matching the subject with the category data, resulting in a number of transactions regarding the subject;
means for comparing the number of transactions regarding the subject with the total number of transactions in the category data, resulting in specific comparison data;
means for presenting the specific comparison data on a presentation interface.

9. The device of claim 8, further comprising:
means for querying a review database about the subject, resulting in reviews;
means for validating the reviews with the specific comparison data;
means for presenting the validated reviews with the specific comparison data.

10. The device of claim 9, wherein the transaction data is an accumulation of individual payment card transactions, each individual payment card transaction including: a payment card indicator, a transaction date, transaction time, and a merchant indicator.

11. The device of claim 10, wherein validating the reviews with the specific comparison data includes a statistical comparison.

12. The device of claim 11, wherein comparing the number of transactions regarding the subject with the total number of transactions in the category data is based on: frequency of purchase, amount purchased, tenure of the business, or percentage share of the wallet.

13. The device of claim 12, comparing the number of transactions regarding the subject with the total number of transactions in the category data is further based on: seasonality of purchases, time of day of purchases, or day of week of purchases.

14. A device to validate query result data comprising:
a network interface configured to receive a query, the query being about a subject, the query containing a time period, and the subject having a predetermined category;
a processor configured to filter transaction data based on the time period and on an opt-in community, resulting in community data within the time period, to filter the community data within the time period on the predetermined category with the processor, resulting in category data, to determine a total number of transactions in the category data, to match the subject with the category data, resulting in a number of transactions regarding the subject, to compare the number of transactions regarding the subject with the total number of transactions in the category data, resulting in specific comparison data;
a presentation interface configured to present the specific comparison data on.

15. The device of claim 14, wherein:
the processor is further configured to querying a review database about the subject, resulting in reviews, to validate the reviews with the specific comparison data, and
the presentation interface is further configured to present the validated reviews with the specific comparison data.

16. The device of claim 15, wherein the transaction data is an accumulation of individual payment card transactions, each individual payment card transaction including: a payment card indicator, a transaction date, transaction time, and a merchant indicator.

17. The device of claim 15, wherein validating the reviews with the specific comparison data includes a statistical comparison.

18. The device of claim 17, wherein comparing the number of transactions regarding the subject with the total number of transactions in the category data is based on: frequency of purchase, amount purchased, tenure of the business, or percentage share of the wallet.

19. The device of claim 18, comparing the number of transactions regarding the subject with the total number of transactions in the category data is further based on: seasonality of purchases, time of day of purchases, or day of week of purchases.

20. The device of claim 17, further comprising:
wherein the query subject is a product or service;
wherein the matching the subject with the category data is accomplished by matching Stock Keeping Unit data within the category data.
